(19) United States
(12) Patent Application Publication
(10) Pub. No.: US 2024/0234750 A9
(43) Pub. Date: Jul. 11, 2024

(54) CONTACTING ASSEMBLY OF A BIPOLAR PLATE AND METHOD FOR CONTACTING A BIPOLAR PLATE

(71) Applicant: Schaeffler Technologies AG & Co. KG, Herzogenaurach (DE)

(72) Inventor: Sebastian Zwahr, Obermichelbach (DE)

(73) Assignee: Schaeffler Technologies AG & Co. KG, Herzogenaurach (DE)

(21) Appl. No.: 18/279,637

(22) PCT Filed: Jan. 25, 2022
(86) PCT No.: PCT/DE2022/100063

§ 371 Date: Aug. 31, 2023

(30) Foreign Application Priority Data
Mar. 4, 2021 (DE) 10 2021 105 215.7

(51) Int. Cl. H01M 8/0247; H01M 8/04537

(52) U.S. Cl. CPC H01M 8/0247; H01M 8/04544

(57) ABSTRACT

A contacting assembly of a bipolar plate having two half-sheets which are spaced apart from one another in parallel and can be attributed to a bipolar plate. Each half-sheet has embossing elements and the embossing elements of the two half-sheets face one another. A connecting pin inserted between the half-sheets makes contact with embossing elements of the half-sheets.

### CROSS-REFERENCE TO RELATED APPLICATIONS

This application is the U.S. National Phase of PCT Appln. No. PCT/DE2022/100063, filed Jan. 25, 2022, which claims the benefit of German Patent Appln. No. 102021105215.7, filed Mar. 4, 2021, the entire disclosures of which are incorporated by reference herein.

### TECHNICAL FIELD

The disclosure relates to a contacting assembly of a bipolar plate, which can be used in particular in a fuel cell. The disclosure further relates to a method for contacting with bipolar plate.

### BACKGROUND

A fuel cell bipolar plate with a socket for measurement connectors is known from EP 1 900 052 Bl. The bipolar plate comprises two half-sheets joined together, which are referred to as the cathodic bipolar half-plate and anodic bipolar half-plate. Each half-sheet comprises a central active zone and a circumferential portion with multiple cutouts. Furthermore, on the circumferential part of the bipolar plate, there is a socket referred to as a hollow receptacle, into which a pin-shaped electrical connecting element can be inserted for measuring purposes. The socket is formed by two opposite ribs, each of which is located in a half-sheet.

WO 2008/145 221 A1 discloses a single fuel cell for a fuel cell stack. A nickel mesh is located inside the single fuel cell as the electrical contacting element. In addition, the use of pastes made of metallic and ceramic materials as contacting elements is proposed.

DE 10 2018 213 688 A1 discloses a connector comprising a plurality of contacting elements for a bipolar stack. Each contact element has a contact body extending along a longitudinal axis, by means of which a channel is formed which is provided for receiving a section of a bipolar plate. A contact spring projects into the channel, which makes contact with the bipolar plate. Furthermore, cutting edges are provided that cut into a surface of the bipolar plate to ensure secure contacting, which is also intended to withstand vibration and impact loads.

DE 20 2005 019 195 U1 describes an interface board with electrical circuitry for connecting a fuel cell. The interface board comprises a printed circuit board on which there are a plurality of interfaces to be connected to a fuel cell and to an electrical device, respectively, wherein the electrical device can be a testing device for testing the fuel cell.

Contacting devices that can be used in the testing and monitoring of fuel cells are also known from documents WO 2014/060 727 A1, WO 2018/236 266 A1, WO 2013/041 869 A1 and WO 2005/069 026 A1.

### SUMMARY

The problem addressed by the disclosure is that of providing further developed options for making contact with a bipolar plate compared with the aforementioned prior art, in particular under the aspects of rational production and low installation space requirements, wherein as far as possible no compromises are to be made with regard to the reliability of the electrical connection.

This problem is solved according to the disclosure by a contacting assembly of a bipolar plate having the features of claim 1. Likewise, the problem is solved by a method for making contact with a bipolar plate according to claim 9. The embodiments and advantages of the disclosure explained below in connection with the contacting method apply, mutatis mutandis, to the devices, i.e., the contacting assembly, as well as a bipolar plate comprising such an assembly, and vice versa.

The contacting assembly comprises two half-sheets which are spaced apart from one another in parallel and can be attributed to a bipolar plate, wherein each half-sheet has embossing elements and the embossing elements of the two half-sheets face one another, and wherein a connecting pin inserted between the half-sheets, which is also referred to as a contacting element or pin for short, makes contact with embossing elements of the half-sheets. In particular, the contacting assembly can be designed in such a way that the connecting pin makes contact exclusively with embossing elements of the half-sheets, but not with flat regions of the half-sheets outside their embossing elements.

The embossing elements of one of the half-sheets or both half-sheets are designed in particular as nubs and can each be part of a larger nub field. Such a nub field can have the task of conducting a fluid along the surface of the bipolar plate, and at the same time mechanically stabilize the bipolar plate. Likewise, variants of the bipolar plate can be realized in which, apart from the nubs which can be attributed to the contacting assembly, no further such nubs are present. In any case, a small distance between the half-sheets parallel to one another is sufficient for the integration of the contacting assembly.

Since the distances between bipolar plates of a fuel cell arranged in a stack are not completely constant and deviations from a nominal value of the distance can add up, a conceivable terminal strip extending across numerous bipolar plates of a stack may not in every case be exactly matched to the actual geometry of the stack in mass-produced fuel cell stacks. The contacting assembly according to the application avoids this problem in that it only serves the contacting of two half-sheets which can be attributed to a single bipolar plate.

According to various possible embodiments, the embossing elements of the one half-sheet attributable to the contacting assembly are arranged offset with respect to at least one embossing element of the other half-sheet also attributable to the contacting assembly, wherein the half-sheets are viewed in a top view. Here, one of the half-sheets has the task of guiding the pin laterally, for which at least two embossing elements are required.

Further improved guidance of the contacting element is possible in variants of the contacting assembly in which the connecting pin makes contact with four embossing elements of the first half-sheet arranged in a rectangular pattern and formed as elevations, and at the same time with a single embossing element of the second half-sheet formed as a depression. In this regard, the connecting pin can be, in each case, tangent to the elevations of the one sheet arranged in a rectangular pattern, in a lateral region of the elevation positioned at an angle of at least 5° and at most 60°, in particular at an angle of 45°±15°, oblique to the planes in which the half-sheets are arranged. Instead of the arrangement of the elevations of the one half-sheet in a rectangular pattern, there can, for example, also be an arrangement of these elevations in a trapezoidal pattern.

In addition to the lateral regions, i.e., the flanks, of the four elevations of one of the two sheets, the connecting pin makes contact with the depression of the other sheet, wherein this depression—again in a top view of the sheets—can be arranged within the rectangle described by the four elevations of the first half-sheet. In particular, the depression can be located in the center of the rectangle. The depression is, in particular, formed mirror-symmetrically to a center plane laid longitudinally through the pin and intersecting the two half-sheets orthogonally.

As far as elasticities within the contacting assembly are concerned, various possibilities exist: On the one hand, the contacting element can be designed as a spring tongue. If this spring tongue is inserted between the half-sheets during assembly, it will bend at least slightly. Similarly, a resilient mounting of the contacting element between the half-sheets can be realized by the embossing elements of at least one of the half-sheets being designed as resilient abutments of the connecting pin, wherein the contacting element in this case can be an inherently rigid pin. This variant, in which the spring action existing within the force-fitting contacting assembly is provided exclusively by the embossed half-sheets, is particularly characterized by the fact that the pin is always arranged parallel to the planes given by the half-sheets, irrespective of forces acting perpendicular to the pin.

Irrespective of the extent to which the spring action is assumed by the half-sheets and/or by the contacting element, the embossing elements of both half-sheets can be at least approximately dome-shaped. During assembly of the contacting assembly, the contacting element is inserted between the half-sheets in such a way that it resiliently contacts a plurality of the, in particular dome-shaped, embossing elements of the half-sheets. The contacting element can initially be placed on one of the half-sheets and thereby laterally guided by a plurality of embossing elements of this half-sheet. Only in a further step of the contacting method is the contacting element loaded by a single embossing element of the second half-sheet. No further contact is made between the connecting pin and the second half-sheet at any time in this method. A connector housing is not provided.

The contacting assembly is particularly suitable for performing a voltage measurement on a bipolar plate. This means that individual voltages of individual cells in a fuel cell stack can be monitored. In addition, the contacting assembly is also suitable for drawing electrical power from an electrochemical cell having the bipolar plate.

### BRIEF DESCRIPTION OF THE DRAWINGS

In the following, an exemplary embodiment of the disclosure is explained in more detail with reference to a drawing. In the figures:

FIG. 1 shows a contacting assembly of a bipolar plate in a top view,

FIG. 2 shows a side view of the assembly shown in FIG. 1,

FIG. 3 shows a perspective view of the assembly shown in FIG. 1.

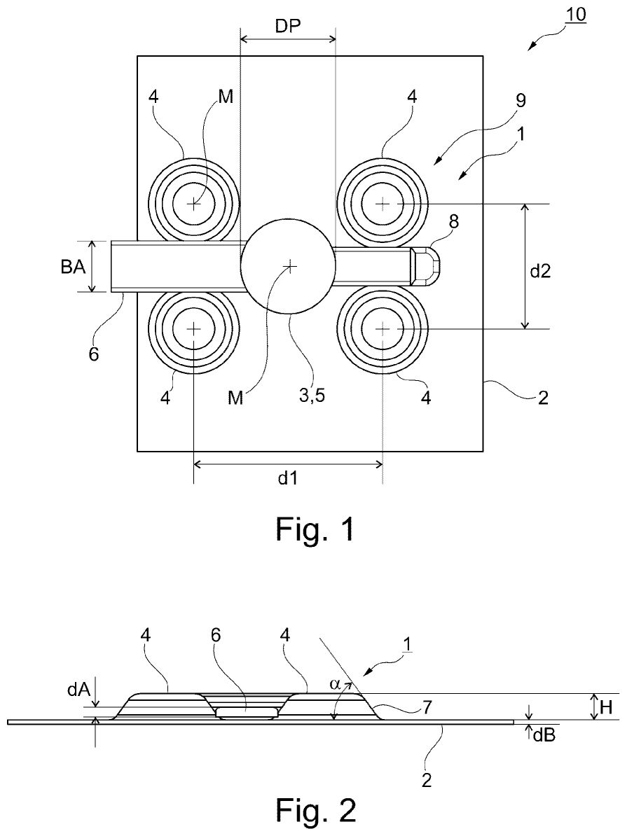

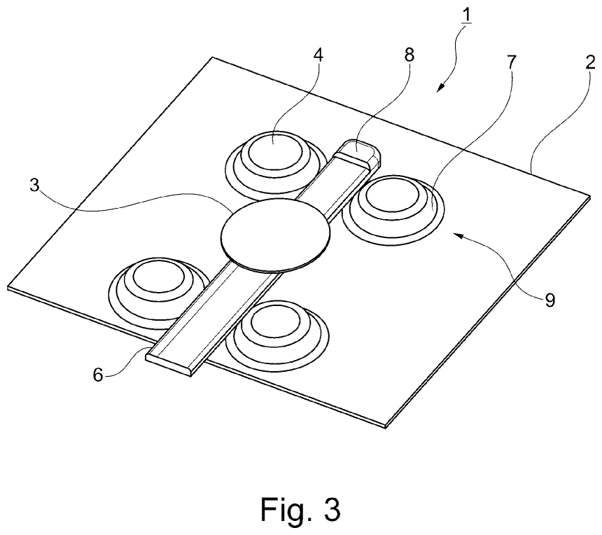

### DETAILED DESCRIPTION

A contacting assembly, designated overall with reference numeral 1, is provided for use in a bipolar plate 10 of a fuel cell, shown only in rudimentary form. With regard to the principle function of bipolar plates in fuel cells, reference is made to the prior art cited at the outset.

The bipolar plate 10 is constructed from two half-sheets 2, 3 arranged parallel to one another, wherein each half-sheet 2, 3 has embossing elements 4, 5. The embossing elements 4, 5 have the basic shape of flattened domes. In the case of the half-sheet 2, the embossing elements 4 are formed as elevations. In contrast, the embossing element 5 of the half-sheet 3 visible in the figures is a depression. Apart from the embossing element 5, no other structures of the half-sheet 3 are shown in the figures. The embossing elements 4, 5 of the various half-sheets 2, 3 face one another and can be components of more expanded nub fields which also have a fluidic function.

In the top view of the contacting assembly 1, the four embossing elements 4 formed by the half-sheet 2 describe a rectangle with a width dl and a height d2. The dimensions d1, d2 refer to the centers of the elevations 4 designated with M. The depression 5 is arranged within the rectangle described by the centers M of the elevations 4, the center of which is also designated with M. All five embossing elements 4, 5 make contact with a connecting pin 6, which is also generally referred to as a contacting element and in the present case is designed as a spring tongue. The connecting pin 6 projecting laterally beyond the half-sheets 2, 3 has a maximum width BA and tapers towards its tip section designated with 8. The tip section 8 is thicker than the rest of the overall plate-like connecting pin 6. The minimum thickness of the connecting pin 6 is designated with dA.

When assembling the contacting assembly 1, the connecting pin 6 is first placed on the half-sheet 2 so that the connecting pin 6 makes lateral contact with the four elevations 4 in each case. The elevations 4 can be attributed to an embossing structure 9 of the half-sheet 2, which can comprise further embossed elements. All embossing elements 4 project from a flat base surface of the half-sheet 2. The thickness of the half-sheet 2 designated with dB is to be measured outside the embossing elements 4, i.e., in the flat region of the half-sheet 2.

The connecting pin 6 remains spaced apart from the flat regions of the half-sheets 2, 3 even when the contacting assembly 1 is fully assembled. The two lateral edges of the connecting pin 6 only make contact with the flanks 7 of the elevations 4. In the example shown, the flanks 7, i.e., the inclined regions of the embossing elements 4, are inclined by an angle α of 45°±15° relative to the plane in which the half-sheet 2 lies. The height of each embossing element 4, 5 is designated with H and is at least twice and at most eight times the sheet thickness dB. This applies to the half-sheet 2 at the bottom in the arrangement shown, as well as to the half-sheet 3 at the top. The arrangement of the half-sheets 2, 3 shown in the figures does not imply any statement about the actual orientation of the bipolar plate 10 in space. In particular, the bipolar plate 10 can be in a vertical orientation in a fuel cell stack.

In the exemplary embodiment, the embossing elements 4, 5 have a uniform diameter DP, which is at least 1.5 times and at most 2.5 times the width BA of the connecting pin 6. In contrast to the elevations 4, the embossing element 5, which is formed as a depression in the half-sheet 3, makes contact with the connecting pin 6 centrally between its two lateral edges. Thus, unlike the embossing elements 4, the embossing element 5 exerts a perpendicular force on the connecting pin 6. Overall, this provides a five-point support for the connecting pin 6.

This support can result in slight bending of the connecting pin 6, which has resilient properties at least to a slight extent, but without contact being established between the connecting pin 6 and the flat regions of the half-sheets 2, 3. In any case, a spring action is provided by an elastic deformation of the embossing elements 4 acting as abutments for the connecting pin.

The minimum thickness of the connecting pin 6, designated with dA, which is uniform except for the tip section 8, is at least twice but not more than four times the sheet thickness dB in the exemplary embodiment. Even more than the elasticity of the connecting pin 6, elastic properties of the embossing elements 4, 5 contribute to the stable retention of the connecting pin 6 between the half-sheets 2, 3. The connecting pin 6 is used for metrological purposes. Furthermore, by means of the connecting pin 6 and other elements not shown, it is possible to draw electrical power from the fuel cell to which the bipolar plate 10 can be attributed.

### LIST OF REFERENCE NUMERALS

1 Contacting assembly
2 Half-sheet
3 Half-sheet
4 Embossing element, elevation
5 Embossing element, depression
6 Connecting pin, contacting element
7 Flank of an embossing element
8 Tip section of connecting pin
9 Embossing structure
10 Bipolar plate
α Flank angle
BA Maximum width of connecting pin
dl Distance between centers of two elevations
d2 Distance between centers of two elevations
dA Minimum thickness of connecting pin
dB Sheet thickness
DP Diameter of an embossing element
H Height of an embossing element

1. A contacting assembly of a bipolar plate comprising: first and second half-sheets spaced apart from one another in parallel, wherein each half-sheet has embossing elements and the embossing elements of the first and second half-sheets face one another, and wherein a connecting pin inserted between the first and second half-sheets makes contact with the embossing elements of the first and second half-sheets.

2. The contacting assembly according to claim 1, wherein the embossing elements of the first half-sheet are offset with respect to at least one embossing element of the second half-sheet.

3. The contacting assembly according to claim 2, wherein the connecting pin makes contact with four embossing elements of the first half-sheet arranged in a rectangular pattern and formed as four elevations and with a single embossing element of the second half-sheet formed as a depression, wherein said depression of the second half-sheet is arranged within the rectangular pattern.

4. The contacting assembly according to claim 3, wherein the connecting pin is tangent to the four elevations arranged in a rectangular pattern, in a lateral region positioned at an angle (α) of at least 5° and at most 60° oblique to the planes in which the half-sheets are arranged, and makes central contact with the depression of the second half-sheet.

5. The contacting assembly according to any one of claim 1, wherein the connecting pin makes contact exclusively with embossing elements of the half-sheets, but not with flat regions of the half-sheets outside the embossing elements.

6. The contacting assembly according to claim 1, wherein the connecting pin comprises a spring tongue.

7. The contacting assembly according to claim 1, wherein the embossing elements of at least one of the half-sheets comprise resilient abutments of the connecting pin.

8. A method of using a contacting assembly of a bipolar plate having two half-sheets spaced apart from one another in parallel, wherein each half-sheet has embossing elements and the embossing elements of the two half-sheets face one another, and wherein a connecting pin inserted between the half-sheets makes contact with the embossing elements of the half-sheets, the method comprising: performing a voltage measurement on the bipolar plate, and drawing electrical power from an electrochemical cell including the bipolar plate.

9. A method for making contact with a bipolar plate constructed from first and second half-sheets, wherein a contacting element is inserted between the first and second half-sheets and resiliently contacts a plurality of at least approximately dome-shaped embossing elements of the first and second half-sheets.

10. The method according to claim 9, wherein the contacting element is initially placed on the first half-sheet and is thereby laterally guided by a plurality of embossing elements of the first half-sheet, and in a further step is loaded by a single embossing element of the second half-sheet.

11. The method according to claim 9, wherein the embossing elements of the first half-sheet are offset with respect to at least one embossing element of the second half-sheet.

12. The method according to claim 11, wherein a connecting pin makes contact with four embossing elements of the first half-sheet arranged in a rectangular pattern and formed as four elevations and with a single embossing element of the second half-sheet formed as a depression, wherein said depression of the second half-sheet is arranged within the rectangular pattern.

13. The method according to claim 12, wherein the connecting pin is tangent to the four elevations arranged in a rectangular pattern, in a lateral region positioned at an angle (α) of at least 5° and at most 60° oblique to the planes in which the half-sheets are arranged, and makes central contact with the depression of the second half-sheet.

14. The method according to claim 8, wherein the connecting pin makes contact exclusively with embossing elements of the half-sheets, but not with flat regions of the half-sheets outside the embossing elements.

15. The method according to claim 8, wherein the connecting pin comprises a spring tongue.

16. The method according to claim 8, wherein the embossing elements of at least one of the half-sheets comprise resilient abutments of the connecting pin.
